(19) United States
(12) Patent Application Publication
(10) Pub. No.: US 2012/0330511 A1
(43) Pub. Date: Dec. 27, 2012

(54) STEERING CONTROL SYSTEM

(75) Inventors: Hisashi KAWASE, Nishio-city (JP); Masashi Hori, Anjo-city (JP); Yasuhiko Mukai, Anjo-city (JP)

(73) Assignees: NIPPON SOKEN, INC., Nishio-City (JP); DENSO CORPORATION, Kariya-City (JP)

(21) Appl. No.: 13/524,100

(22) Filed: Jun. 15, 2012

(30) Foreign Application Priority Data
Jun. 22, 2011 (JP) 2011-138165

(51) Int. Cl. B62D 6/00; B62D 6/08; B62D 6/02

(52) U.S. Cl. 701/41

(57) ABSTRACT

In a steering control system, an ECU calculates a basic transfer ratio in accordance with a steering angle detected by a steering angle sensor or a corrected transfer ratio by correcting the calculated basic transfer ratio in accordance with the position of a rack. The corrected transfer ratio decreases when the rack moves from a predetermined first position close to one end of a movable range, to the one end or from a predetermined second position close to the other end of the movable range, to the other end. The ECU determines either the basic transfer ratio or the corrected transfer ratio as the transfer ratio in accordance with the position of the rack. The ECU controls an actuator for a variable gear ratio system in accordance with the transfer ratio.

### CROSS REFERENCE TO RELATED APPLICATION

This application is based on and incorporates herein by reference Japanese patent application No. 2011-138165 filed on Jun. 22, 2011.

### TECHNICAL FIELD

The present disclosure relates to a steering control system that controls the steering operation of a vehicle's steering wheel.

### BACKGROUND ART

A conventional variable gear ratio steering system (VGRS system) changes the ratio between the steering angle of a steering wheel and the rudder angle of a steered tire wheel, that is, the steered angle. A vehicle steering control system disclosed, for instance, in JP 2000-344120A includes a variable transfer ratio mechanism that drives an electrically-operated actuator to change a transfer ratio, which is the ratio between the steering angle and the steered angle, and operates the variable transfer ratio mechanism to set a high transfer ratio for a low speed region where the travel speed of the vehicle is low.

When the steering wheel continuously rotates in one direction due to the steering operation of a driver of the vehicle, the vehicle steering control system allows the end of a rack, which turns the steered wheel, to collide, for instance, against the inner wall of a rack housing, which houses the rack. This stops not only the longitudinal movement of the rack but also the rotation of the steered wheel. The vehicle steering control system is set so that a high transfer ratio is used in the low speed region where the speed of the vehicle is low. Therefore, when, for instance, the driver performs an abrupt steering operation particularly in the low speed region, the movement speed of the rack is high when the rack collides against the rack housing. As the energy of collision is proportional to the square of speed, it is estimated that a high collision torque may be generated due to the collision between the rack and the rack housing.

In some cases, the peak value of collision torque may be more than ten times a normal steering torque. Therefore, when the rack collides against the rack housing, gears included in the variable transfer ratio mechanism may be damaged by excessive impact. To avoid damage to the gears, it is necessary to set a high safety factor for the gears in consideration of the collision torque between the rack and the rack housing. When a high safety factor is set for the gears, the variable transfer ratio mechanism and the steering control system may increase in physical size.

In recent years, an electric power steering system, which generates torque with an electrically-operated actuator, is used together with the VGRS system as a mechanism for providing assistance to a vehicle's steering operation, that is, a steering force assist mechanism. When the electric power steering system assists a steering force while the transfer ratio is increased by the VGRS device, the collision torque between the rack and the rack housing may further increase.

### SUMMARY

It is therefore an object to provide a steering control system compact, which is lightweight and capable of preventing damage to structural members.

According to one aspect, a steering control system is provided for a vehicle having an input shaft coupled to a steering wheel of the vehicle, an output shaft disposed rotatably relative to the input shaft, a rack that reciprocates in a longitudinal direction when the output shaft rotates, a steered wheel that turns when the rack reciprocates, and a rack housing in which the rack is reciprocally housed. The steering control system comprises a variable transfer ratio mechanism, a steering angle detection device, a corrected transfer ratio calculation section, a transfer ratio determination section and a first drive control section.

The variable transfer ratio mechanism includes a first gear mechanism that transmits rotation of the input shaft to the output shaft and a first actuator that drives the first gear mechanism. The variable transfer ratio mechanism provides a variable transfer ratio, which is the ratio between the rotation angle of the output shaft indicating a steered angle and the rotation angle of the input shaft indicating a steering angle of the steering wheel.

The steering angle detection device detects the steering angle.

The basic transfer ratio calculation section calculates a basic transfer ratio in accordance with the steering angle detected by the steering angle detection device.

The corrected transfer ratio calculation section calculates a corrected transfer ratio by correcting the basic transfer ratio in accordance with a position of the rack.

The transfer ratio determination section determines either the basic transfer ratio or the corrected transfer ratio as a transfer ratio in accordance with the position of the rack.

The first drive control section controls the first actuator in accordance with the transfer ratio determined by the transfer ratio determination section.

The corrected transfer ratio calculation section calculates the corrected transfer ratio by making corrections so that a value of the basic transfer ratio decreases when the rack moves from a predetermined first position, which is close to a first end of a movable range, to the first end or from a predetermined second position, which is close to a second end of the movable range opposite to the first end, to the second end.

The transfer ratio determination section determines the basic transfer ratio as the transfer ratio when the rack is between the first position and the second position, and determines the corrected transfer ratio as the transfer ratio when the rack is between the first position and the first end or between the second position and the second end.

### BRIEF DESCRIPTION OF THE DRAWINGS

The above and other objects, features and advantages will become more apparent from the following detailed description made with reference to the accompanying drawings. In the drawings:

FIG. 1 is a schematic diagram illustrating a steering control system according to a first embodiment;

FIG. 2 is a flowchart illustrating a steering process performed by the steering control system according to the first embodiment;

FIG. 3A is a graph illustrating a basic transfer ratio that is calculated by a basic transfer ratio calculation section;

FIG. 3B is a graph illustrating a correction factor that a corrected transfer ratio calculation section uses to calculate a corrected transfer ratio;

FIG. 4 is a time chart illustrating a collision torque exerted on the steering control system according to the first embodiment and a collision torque exerted on a comparative example of the steering control system;

FIG. 5 is a schematic diagram illustrating a steering control system according to a second embodiment;

FIG. 6 is a flowchart illustrating a steering process performed by the steering control system according to the second embodiment;

FIG. 7 is a schematic diagram illustrating a steering control system according to a third embodiment;

FIG. 8 is a flowchart illustrating a steering process performed by the steering control system according to the third embodiment;

FIG. 9 is a schematic diagram illustrating steering control system according to a fourth embodiment; and

FIG. 10 is a flowchart illustrating a steering process performed by the steering control system according to the fourth embodiment.

### DETAILED DESCRIPTION OF THE INVENTION

A steering control system will now be described with reference to various embodiments, in which substantially the same components or elements are designated by the same reference numerals for brevity.

### First Embodiment

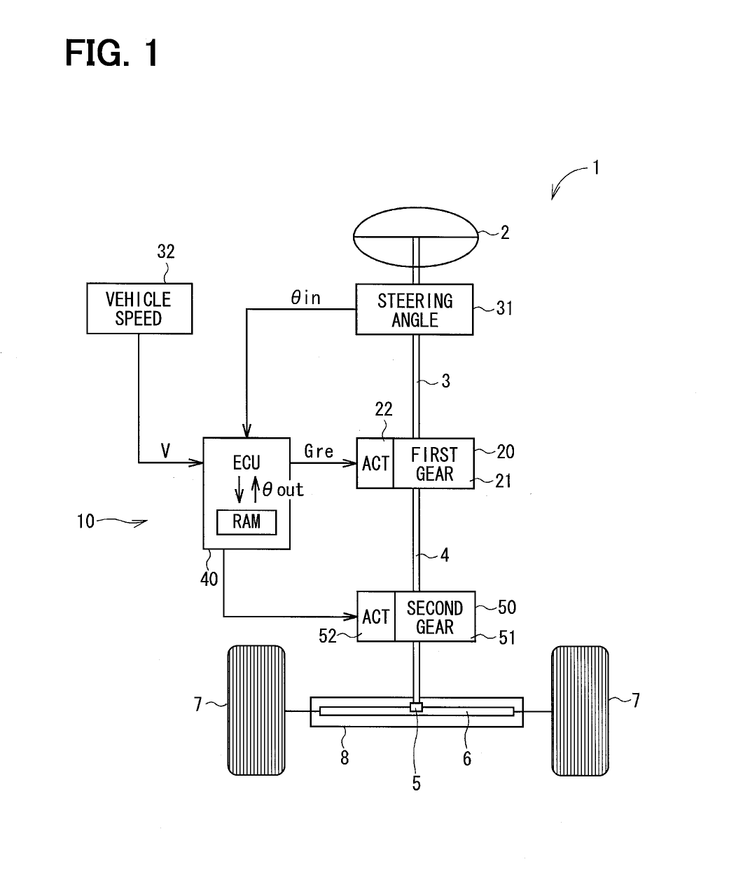

Referring to FIG. 1, a steering control system 10 is applied to a vehicle 1 and used to control a vehicle steering operation performed by a driver of a vehicle.

The vehicle 1 includes, for example, a steering wheel 2, an input shaft 3, an output shaft 4, a rack 6, a steered tire wheel (steered wheel) 7, and a rack housing 8. The input shaft 3 is coupled to the steering wheel 2 that is steered by the driver. A rotation angle of the input shaft 3 that is rotated when the steering wheel 2 is rotated for steering purposes is referred to as the steering angle.

The output shaft 4 is disposed so that it rotates relative to the input shaft 3. The input shaft 3 and the output shaft 4 form a column shaft. A steering pinion 5 is disposed at an end of the output shaft 4 to engage with the rack 6. This ensures that the rack 6 reciprocates in its longitudinal direction (lateral direction of a vehicle) when the output shaft 4 rotates. That is, the rack 6 and the steering pinion 5 form a rack-and-pinion mechanism. The steered wheel 7 is disposed at both ends of the rack 6. This permits the steered wheel 7 to turn when the rack 6 reciprocates. The rotation angle of the output shaft 4 that is formed when the steered wheel 7 turns is referred to as the steered angle (turn angle).

The rack 6 is reciprocally housed in the rack housing 8. The end of the rack 6 abuts against the inner wall of the rack housing 8 to restrict a longitudinal reciprocating motion of the rack 6, that is, a stroke of the rack 6. That is, the rack 6 reciprocates within a predetermined range (movable range) in the rack housing 8.

The steering control system 10 includes a variable transfer ratio mechanism 20, a steering angle sensor 31, and an electronic control unit (ECU) 40, for example. The variable transfer ratio mechanism 20 includes a first gear mechanism 21 and a first actuator 22. The steering angle sensor 31 serves as a steering angle detection device.

The first gear mechanism 21 is disposed between the input shaft 3 and the output shaft 4 and configured to transmit the rotation of the input shaft 3 to the output shaft 4. The first gear mechanism 21 is a differential gear mechanism that includes, for example, two side gears, pinion gears disposed between the side gears, and a ring gear. The pinion gears are rotatably retained by the ring gear. The input shaft 3 is connected to one of the two side gears of the first gear mechanism 21. The output shaft 4 is connected to the other side gear. Therefore, when the input shaft 3 rotates, the pinion gears between the side gears rotate to rotate the output shaft 4 in a direction opposite the rotation direction of the input shaft 3.

When the ring gear, which retains the pinion gears, is fixed and unable to rotate, the rotation speed of the input shaft 3 is the same as that of the output shaft 4. In this instance, therefore, a transfer ratio, which is the ratio between the rotation angle of the output shaft 4, that is, the steered angle, and the rotation angle of the input shaft 3, that is, the steering angle, is 1:1, namely, 1.

As described above, the first gear mechanism 21 is a differential gear mechanism. Therefore, the rotation direction of the output shaft 4 is opposite to that of the input shaft 3. In the vehicle 1 to which the steering control system 10 is applied, the steering pinion 5 disposed at the end of the output shaft 4 engages with the rear side of the rack 6 as viewed toward the rear of the vehicle 1. The rack 6 is connected to the steered wheel 7 at a point displaced rearward from the rotation center of the steered wheel 7 as viewed toward the rear of the vehicle 1. Therefore, when the driver rotates the steering wheel 2 (input shaft 3) clockwise (rightward) for steering purposes, the output shaft 4 rotates counterclockwise (leftward), thereby causing the rack 6 to move leftward as viewed toward the front of the vehicle 1. This changes the steered angle of the steered wheel 7 so as to move the vehicle 1 rightward (causes the steered wheel 7 to turn rightward). When, on the other hand, the driver rotates the steering wheel 2 (input shaft 3) counterclockwise (leftward), the output shaft 4 rotates clockwise (rightward), thereby causing the rack 6 to move rightward as viewed toward the front of the vehicle 1. This changes the steering angle of the steered wheel 7 so as to move the vehicle 1 leftward (causes the steered wheel 7 to turn leftward).

The first actuator 22 is an electric motor. The first actuator 22 includes a worm gear that engages with external teeth formed on an outer end of the ring gear of the first gear mechanism 21. The first actuator 22 can rotationally drive the ring gear of the first gear mechanism 21 by rotationally driving the worm gear.

When the ring gear is rotationally driven by the first actuator 22, the pinion gears retained by the ring gear rotate together with the ring gear. Therefore, when the ring gear rotates, the transfer ratio changes. When, for instance, the ring gear rotates in the same direction as the input shaft 3, that is, in a direction opposite to the rotation direction of the output shaft 4, the transfer ratio is lower than 1. When, on the other hand, the ring gear rotates in a direction opposite the rotation direction of the input shaft 3, that is, in the same direction as the output shaft 4, the transfer ratio is higher than 1.

As described above, the first embodiment is configured so that the variable transfer ratio mechanism 20 is formed by the first gear mechanism 21 and the first actuator 22. The variable transfer ratio mechanism 20 drives the first actuator 22 and the first gear mechanism 21 to provide a variable transfer ratio.

The steering angle sensor 31 is mounted on the input shaft 3 to detect the rotation angle of the input shaft 3, that is, the steering angle.

The ECU 40 includes, for instance, a microcomputer having a computation section, such as a CPU, and storage sections, such as a RAM and a ROM. The ECU 40 is used to control various devices mounted on the vehicle 1 to which the steering control system 10 is applied. Signals output from the steering angle sensor 31 and various other sensors disposed in various sections of the vehicle 1 are input into the ECU 40. The ECU 40 controls the various devices mounted on the vehicle 1 in accordance with the various input signals and with a predetermined control program stored in the ROM.

The steering angle sensor 31 outputs a signal indicating a detected steering angle to the ECU 40.

The ECU 40 is also connected to the first actuator 22. The ECU 40 can control the rotational drive of the first actuator 22 by adjusting electrical power supplied to the first actuator 22. The ECU 40 can control the drive of the first gear mechanism 21 by controlling the rotational drive of the first actuator 22. Consequently, the ECU 40 can control the drive of the first actuator 22 so that the above-described transfer ratio takes a desired value.

The vehicle 1 includes, for example, a vehicle speed sensor 32, a second gear mechanism 51, a second actuator 52, and a steering force assist mechanism 50 in addition to the above-described devices. The vehicle speed sensor 32 serves as a speed detection section.

The vehicle speed sensor 32 is mounted on the vehicle 1 to detect the speed of the vehicle 1, that is, the vehicle speed. The vehicle speed sensor 32 outputs a signal indicating the detected vehicle speed to the ECU 40.

The second gear mechanism 51 is mounted on the output shaft 4. The second gear mechanism 51 includes a gear that engages with the output shaft 4.

The second actuator 52 is an electric motor. The second actuator 52 includes a worm gear that engages with external teeth formed on an outer end of the gear of the second gear mechanism 51. The second actuator 52 can rotationally drive the gear of the second gear mechanism 51 by rotationally driving the worm gear.

When the gear of the second gear mechanism 51 is rotationally driven by the second actuator 52, the torque arising from the rotation of the gear of the second gear mechanism 51 is applied to the output shaft 4. The driver's steering of the steering wheel 2 can be assisted by applying torque from the second actuator 52 through the second gear mechanism 51 in the same direction as the rotation direction of the output shaft 4 that is rotated when the driver rotates the steering wheel 2 for steering purposes. That is, the torque applied to the output shaft 4 when the second actuator 52 and the second gear mechanism 51 are driven turns out to be assist torque for steering force (steering torque) that is input to the steering wheel 2 from the driver.

As described above, the steering force assist mechanism 50 is formed by the second gear mechanism 51 and the second actuator 52. The steering force assist mechanism 50 assists the driver's steering of the steering wheel 2 by using the assist torque that is generated when the second actuator 52 and the second gear mechanism 51 are driven. In the present embodiment, the steering force assist mechanism 50 is a part of a column assist electric power steering device.

The ECU 40 is also connected to the second actuator 52. The ECU 40 controls the rotational drive of the second actuator 52 by adjusting electrical power supplied to the second actuator 52. The ECU 40 controls the drive of the second gear mechanism 51 by controlling the rotational drive of the second actuator 52. Consequently, the ECU 40 can control the second actuator 52 so that the above-described assist torque attains a desired value. The ECU 40 determines the assist torque in accordance with a signal from a torque sensor (not shown) that detects the steering torque, which is input to the input shaft 3 when the driver steers the steering wheel 2, and controls the drive of the second actuator 52 so as to apply the determined assist torque to the output shaft 4.

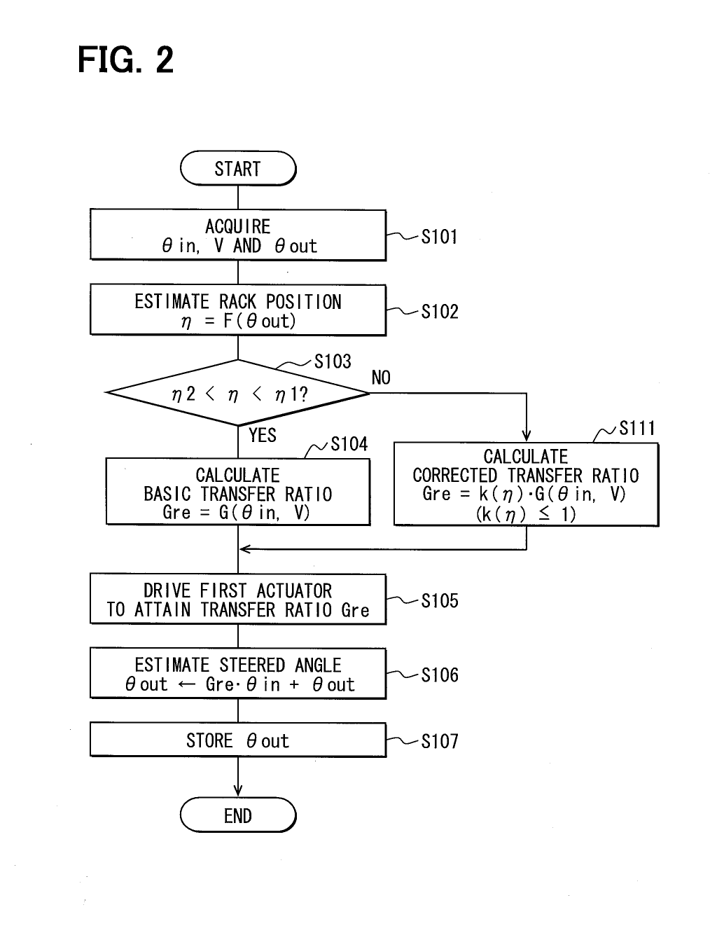

The ECU 40 is programmed to perform a steering process shown in FIG. 2. A series of processing steps shown in FIG. 2 is initiated when, for instance, the driver turns on an ignition key of the vehicle 1.

In step S101, the ECU 40 acquires various signals (information) from the sensors and the RAM (memory). The ECU 40 acquires the rotation angle of the input shaft 3 that is detected by the steering angle sensor 31, namely, the steering angle θin. The ECU 40 acquires the travel speed of the vehicle 1 that is detected by the vehicle speed sensor 32, namely, the vehicle speed V. The ECU 40 also acquires the steered angle θout stored in the RAM. In step S101, the steered angle θout stored in the RAM corresponds to the current rotation angle of the output shaft 4, namely, the steered angle. The storage of the steered angle θout into the RAM will be described later.

Upon completion of step S101, processing proceeds to step S102. In step S102, the ECU 40 estimates, a rack position, that is, the position of the rack 6. More specifically, the ECU 40 estimates the position of the rack 6 in accordance with the steered angle θout acquired in step S101. That is, the ECU 40 calculates a position η of the rack 6 in accordance with a function whose variable is θout to estimate the position of the rack 6 by the following equation (1).

η=F(θout) (1)

where η is a value between −100 and 100(%). It is assumed that the position η of the rack 6 is 0(%) when the steering wheel 2, the input shaft 3, the output shaft 4, and the steered wheel 7 are in neutral position. It means that the rack 6 is positioned at the center of the movable range.

When the steering wheel 2 is allowed to continuously rotate in one direction (e.g., clockwise), the rack 6 moves in one longitudinal direction so that its end abuts against the inner wall of the rack housing 8. This restricts the longitudinal movement of the rack 6, that is, the stroke of the rack 6. It is assumed that the prevailing position η of the rack 6 i (%). More specifically, when η i, it means that the rack 6 is positioned at one end (first end) of the movable range, namely, at one maximum stroke position.

When the steering wheel 2 is allowed to continuously rotate in the other direction (e.g., counterclockwise), the rack 6 moves in the other longitudinal direction so that its end abuts against the inner wall of the rack housing 8. This restricts the longitudinal movement of the rack 6, that is, the stroke of the rack 6. It is assumed that the prevailing position η of the rack 6 i (%). More specifically, when η i, it means that the rack 6 is positioned at the other end (second end) of the movable range, namely, at the other maximum stroke position opposite to the one maximum stroke position.

Upon completion of step S102, processing proceeds to step S103. In step S103, the ECU 40 checks whether the rack position η is between a first threshold value and a second threshold value. It is assumed that the first threshold value η1 is 90 while the second threshold value η2 is −90. That is, the first threshold value corresponds to a predetermined first position close to one end of the movable range of the rack 6. On the other hand, the second threshold value η2 corresponds to a predetermined second position close to the other end of the movable range of the rack 6, namely, the second position.

When the rack position η is determined to be between the first threshold value and the second threshold value, that is, when −90<η<90 (when the determination in step S103 is YES), processing proceeds to step S104. If, on the other hand, the rack position η is not determined to be between the first threshold value and the second threshold value, that is, when η≦−90 or 90 (when the determination in step S103 is NO), processing proceeds to step S111.

In step S104, the ECU 40 calculates a basic transfer ratio. The basic transfer ratio is calculated in accordance with the steering angle θin and vehicle speed V acquired in step S101. The basic transfer ratio is calculated in accordance with a function whose variables are θin and V by the following equation (2).

Gre=G(θin,V) (2)

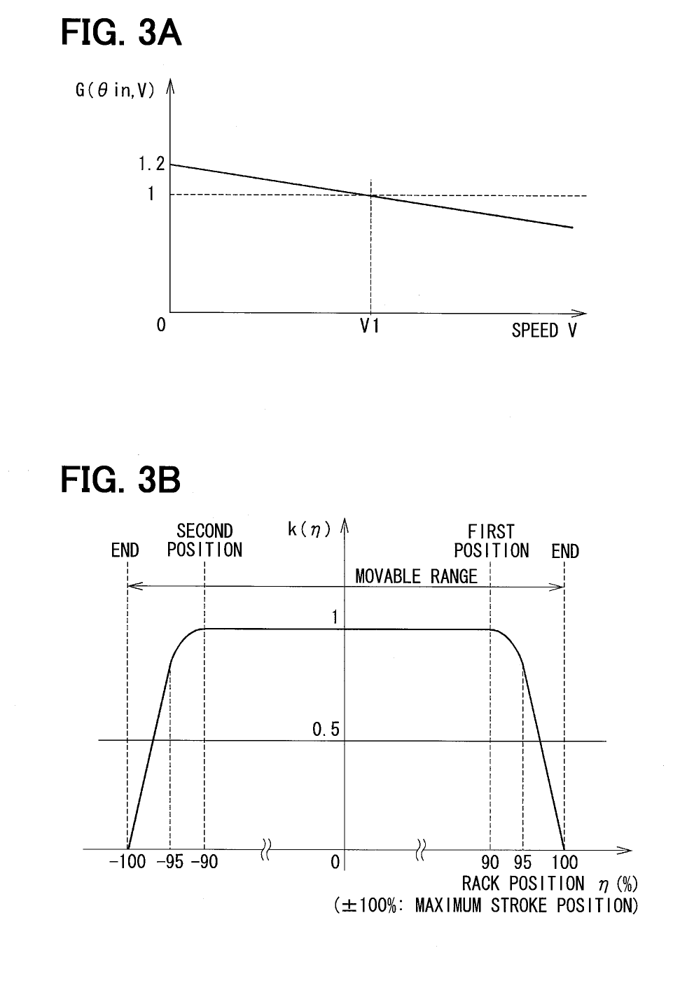

The basic transfer ratio G(θin, V) is defined as a function of θin and V as shown in FIG. 3A. As shown in FIG. 3A, calculations performed by the ECU 40 are such that the value of the basic transfer ratio G(θin, V) increases with a decrease in the value of the vehicle speed V, and that the value of the basic transfer ratio G(θin, V) decreases with an increase in the value of the vehicle speed V. The calculations performed are such that the basic transfer ratio G(θin, V) is 1.2 when the vehicle speed V is 0, and that the basic transfer ratio G(θin, V) is 1 when the vehicle speed V is a predetermined speed V1.

The ECU 40 then sets the calculated basic transfer ratio G(θin, V) into a transfer ratio Gre. That is, the ECU 40 determines the basic transfer ratio G(θin, V) as the transfer ratio Gre.

Upon completion of step S104, processing proceeds to step S105. In step S111, the ECU 40 calculates a corrected transfer ratio. The corrected transfer ratio is calculated by correcting the basic transfer ratio in accordance with the position of the rack 6, namely, the position η of the rack 6 that is estimated in step S102. More specifically, the corrected transfer ratio is calculated by multiplying the basic transfer ratio G(θin, V) by a correction factor k(η) that is calculated in accordance with the position η of the rack 6.

The correction factor k(η) is a value not greater than 1. The correction factor k(η) is defined as a function of the rack position η is shown in FIG. 3B. As shown in FIG. 3B, the correction factor k(η) is 1 when −90<η<90. When 90≦η≦100 and η changes from 90 to 100, the correction factor k(η) gradually decreases from 1 to 0. Further, when −100≦η≦−90 and η changes from −90 to −100, the correction factor k(η) gradually decreases from 1 to 0. When η i or −100, the correction factor k(η) is 0.

As shown in FIG. 3B, when η changes from 90 to 95 or from −90 to −95, the correction factor k(η) used in the present embodiment decreases gradually in a curved manner. Further, when η changes from 95 to 100 or from −95 to −100, the correction factor k(η) decreases gradually in a linear manner.

The method of calculating the basic transfer ratio G(θin, V) is the same as described in connection with step S104.

The corrected transfer ratio is calculated by the following equation (3).

Gre=k(η)·G(θin,V) (3)

That is, the calculated corrected transfer ratio k(η)·G(θin, V) decreases when the rack 6 moves from the first position (90%) to one end (100%) or from the second position (−90%) to the other end (−100%).

The ECU 40 then sets the calculated corrected transfer ratio k(η). G(θin, V) into the transfer ratio Gre. It means that the ECU 40 determines the corrected transfer ratio k(η)·G(θin, V) as the transfer ratio Gre.

Upon completion of step S111, processing proceeds to step S105. In step S105, the ECU 40 sets the transfer ratio Gre, which is determined in step S104 or S111, as the transfer ratio, and controls the drive of the first actuator 22 of the variable transfer ratio mechanism 20 so as to attain the transfer ratio determined as above.

Upon completion of step S105, processing proceeds to step S106. In step S106, the ECU 40 estimates the current rotation angle of the output shaft 4, that is, the steered angle. More specifically, the steered angle θout prevailing in step S106 is estimated by adding the steered angle θout acquired in step S101 to the product of the transfer ratio Gre used in step S105 and the steering angle θin acquired in step S101 by the following equation 4.

θout=Gre·θin+θout (4)

Upon completion of step S106, processing proceeds to step S107. In step S107, the ECU 40 stores the steered angle θout, which is estimated in step S106, in the RAM.

Upon completion of step S107, processing finishes the series of processing steps of FIG. 2. Subsequently, when the ignition key is in the on-state, the ECU 40 resumes the series of processing steps shown in FIG. 2. That is, the series of processing steps shown in FIG. 2 is repeatedly performed when the ignition key is in the on-state.

The steered angle θout stored in the RAM in step S107 will be acquired by the ECU 40 when it performs step S101 a second time.

As described above, in step S102, the ECU 40 functions as the rack position estimation section. In steps S103 and S104 and in steps S103 and S111, the ECU 40 functions as the transfer ratio determination section In steps S104 and S111, the ECU 40 functions as the basic transfer ratio calculation section. In step S111, the ECU 40 functions as the corrected transfer ratio calculation section. In step S105, the ECU 40 functions as the first drive control section. In step S106, the ECU 40 functions as the steered angle estimation section.

As described above, the ECU 40 includes the rack position estimation section, the transfer ratio determination section, the basic transfer ratio calculation section, the corrected transfer ratio calculation section, the first drive control section, and the steered angle estimation section as functional elements.

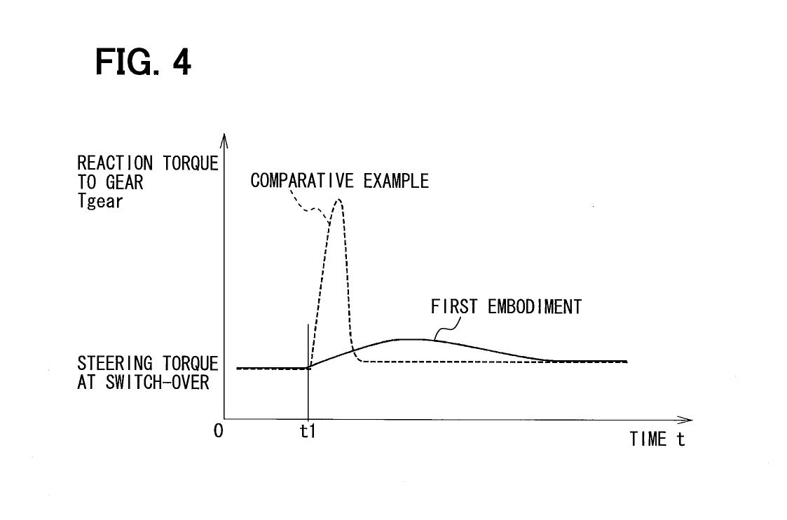

In the first embodiment, performing the above-described process makes it possible to decrease the movement speed of the rack 6 when it collides against the rack housing 8. Thus, the collision energy between the rack 6 and the rack housing 8 can be reduced. As a result, when the rack 6 collides against the rack housing 8, the torque applied to the gears included in the first gear mechanism 21 (collision torque Tgr) as a reaction can be reduced. This advantage will be described below in detail with reference to a comparative example (see FIG. 4).

The solid line in FIG. 4 indicates temporal changes in Tgr that occur when the steering wheel 2 is continuously rotated in one direction (dry-steered) while the vehicle 1 to which the steering control system 10 that performs the above-described series of processing steps is applied is stopped (vehicle speed V=0). The broken line in FIG. 4, on the other hand, indicates temporal changes in Tgr that occur when the steering wheel 2 is continuously rotated in one direction while the vehicle 1 to which a steering control system according to a comparative example is applied is stopped. Here, it is assumed that the steering control system according to the comparative example has the same physical configuration as the steering control system 10 and performs the above-described steering processing steps except for steps S102, S103, S106, S107, and S111. That is, the steering control system according to the comparative example increases or decreases the basic transfer ratio in accordance with the vehicle speed, but does not correct the basic transfer ratio.

As is obvious from FIG. 4, in a situation where the steering control system according to the comparative example is used, a high collision torque Tgr is applied to the gears in the first gear mechanism 21 (the peak value of the collision torque Tgr is great) when the rack 6 collides against the rack housing 8 at time t1. However, in a situation where the steering control system 10 according to the first embodiment is used, the peak value of the collision torque Tgr applied to the gears in the first gear mechanism 21 is small even when the rack 6 collides against the rack housing 8 at time t1. As discussed above, the peak value of the collision torque generated when the rack 6 collides against the rack housing 8 is considerably smaller in the first embodiment than in the comparative example.

As described above, the ECU 40 (corrected transfer ratio calculation section) calculates the corrected transfer ratio by making corrections so that the basic transfer ratio decreases when the rack 6 moves from the predetermined first position (90%), which is close to the one end (100%) of the movable range, to the one end, or from the predetermined second position (−90), which is close to the other end (−100) of the movable range, which is opposite to the one end.

When the rack 6 is between the first position and the second position, the ECU 40 (transfer ratio determination section) determines the basic transfer ratio calculated by the basic transfer ratio calculation section as the transfer ratio. When, on the other hand, the rack 6 is between the first position and the one end or between the second position and the other end, the ECU 40 (transfer ratio determination section) determines the corrected transfer ratio calculated by the corrected transfer ratio calculation section as the transfer ratio.

In a situation where the rack 6 is positioned close to one end or the other end of its movable range, the above-described configuration makes corrections so that the transfer ratio decreases when the driver steers the steering wheel 2 to move the rack 6 toward the one end or the other end of the movable range, that is, the rack 6 approaches the maximum stroke position. This decreases the movement speed of the rack 6 when it collides against the rack housing 8. As a result, the collision torque between the rack 6 and the rack housing 8 can be reduced. Thus, an allowable torque can be set for the first gear mechanism 21 in accordance with a normal steering torque, which is significantly lower than the collision torque. Hence, the size of the first gear mechanism 21 can be reduced. This makes it possible not only to decrease the physical size and weight of the steering control system 10, but also to reduce the cost of manufacturing the steering control system 10. Further, as the collision torque between the rack 6 and the rack housing 8 is reduced, damage to the first gear mechanism 21 can be avoided to increase the reliability of the steering control system 10.

The second embodiment further includes the vehicle speed sensor 32, which detects the speed of the vehicle 1, that is, the vehicle speed. The ECU 40 (basic transfer ratio calculation section) performs calculations so that the value of the basic transfer ratio increases with a decrease in the value of the speed of the vehicle 1, which is detected by the vehicle speed sensor 32, and decreases with an increase in the value of the speed of the vehicle 1, which is detected by the vehicle speed sensor 32. Consequently, increased convenience is provided by setting a high transfer ratio for the low speed region where the speed of the vehicle 1 is low. Further, increased running stability is provided by setting the low transfer ratio for a high speed region where the speed of the vehicle 1 is high.

In the low speed region where the speed of the vehicle 1 is low, the basic transfer ratio calculated by the basic transfer ratio calculation section is high. Therefore, it is anticipated that the collision torque between the rack 6 and the rack housing 8 may be high particularly in the low speed region. However, the ECU 40 (corrected transfer ratio calculation section) calculates the corrected transfer ratio by making corrections so that the value of the basic transfer ratio decreases when the rack 6 approaches one end (100%) or the other end (−100%) of its movable range, that is, when the rack 6 approaches the maximum stroke position. Therefore, even when the basic transfer ratio calculated by the basic transfer ratio calculation section is high in the low speed region, the corrected transfer ratio calculation section decreases the basic transfer ratio for correction purposes when the rack 6 is positioned close to the maximum stroke position. Thus, the collision torque between the rack 6 and the rack housing 8 can be effectively reduced. As described above, the first embodiment is suitable for the steering control system for which a high transfer ratio is set in accordance with the speed of the vehicle 1.

The first embodiment further includes the rack position estimation section for estimating the position of the rack 6 in accordance with the steered angle, which is the rotation angle of the output shaft 4. The ECU 40 (corrected transfer ratio calculation section) corrects the basic transfer ratio in accordance with the position of the rack 6, which is estimated by the rack position estimation section. In addition, the ECU 40 (transfer ratio determination section) determines the transfer ratio in accordance with the position of the rack 6, which is estimated by the rack position estimation section. As described above, the present embodiment does not use, for instance, a detection section that actually detects the position of the rack 6, but uses the ECU 40 (rack position estimation section) to estimate the position of the rack 6 and allows the corrected transfer ratio calculation section to correct the basic transfer ratio.

The first embodiment further includes the steered angle estimation section for estimating the steered angle in accordance with the steering angle detected by the steering angle sensor 31 and the transfer ratio determined by the ECU 40 (transfer ratio determination section). The ECU 40 (rack position estimation section) estimates the position of the rack 6 in accordance with the steered angle estimated by the steered angle estimation section. As described above, the first embodiment does not use, for instance, a detection section that actually detects the steered angle, but uses the ECU 40 (rack position estimation section) to estimate the position of the rack 6. This makes it possible to decrease the number of employed members.

### Second Embodiment

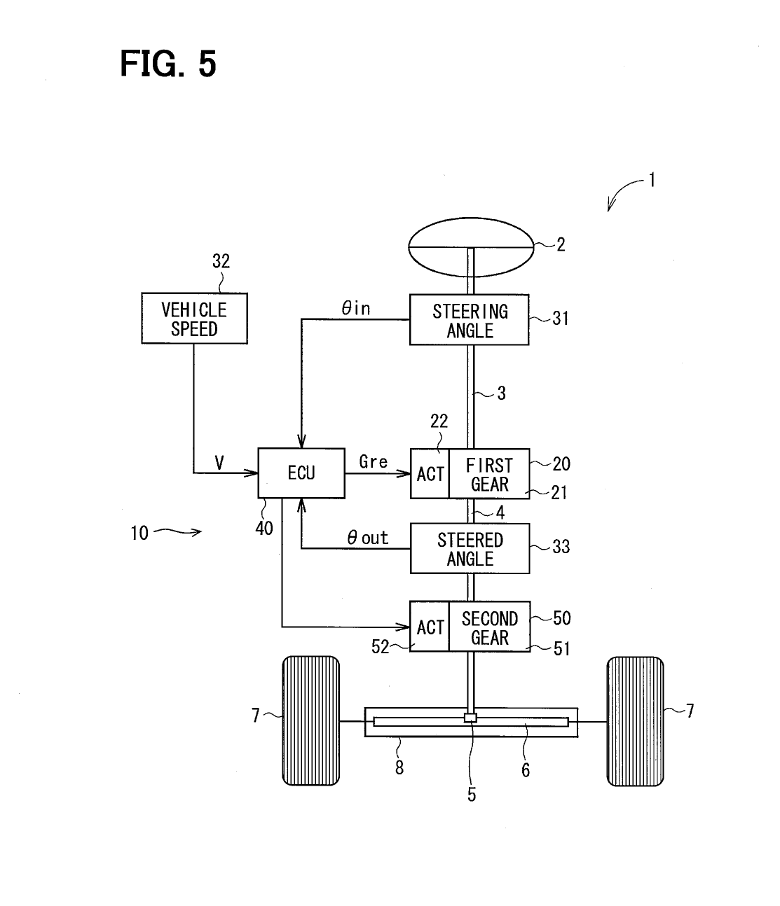

A steering control system 10 according to a second embodiment is shown in FIG. 5. The second embodiment differs from the first embodiment in its configuration and partly differs from the first embodiment in steering-related processing.

The second embodiment further includes a steered angle sensor 33, which serves as a steered angle detection device. The steered angle sensor 33 is mounted on the output shaft 4 to detect the rotation angle of the output shaft 4, that is, the steered angle. The steered angle sensor 33 outputs a signal indicating the detected steered angle to the ECU 40.

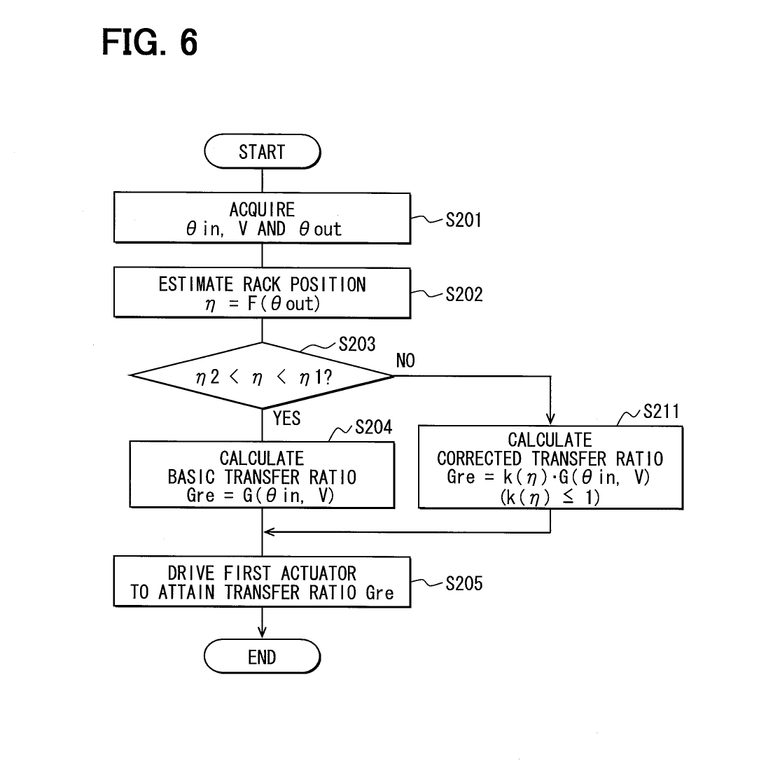

An operation of the steering control system 10 according to the second embodiment will now be described with reference to FIG. 6.

The ECU 40 is programmed to perform a steering process shown in FIG. 6. A series of processing steps shown in FIG. 6 is initiated when, for instance, the driver turns on the ignition key of the vehicle 1.

In step S201, the ECU 40 acquires various signals (information) from the sensors. The ECU 40 acquires the rotation angle of the input shaft 3 that is detected by the steering angle sensor 31, namely, the steering angle θin. The ECU 40 acquires the speed of the vehicle 1 that is detected by the vehicle speed sensor 32, namely, the vehicle speed V. The ECU 40 also acquires the steered angle θout detected by the steered angle sensor 33.

Upon completion of step S201, processing proceeds to step S202. In step S202, the ECU 40 estimates the position of the rack 6. More specifically, the ECU 40 estimates the position of the rack 6 in accordance with the steered angle θout acquired in step S201. The method of estimating the position of the rack 6 is the same as described in connection with step S102, which is performed in the first embodiment. Step S202 differs from step S102, which is performed in the first embodiment, in that the steered angle θout used in step S102 is estimated by the ECU 40 (steered angle estimation section) whereas the steered angle θout used in step S202 is detected by the steered angle sensor 33.

Upon completion of step S202, processing proceeds to step S203. In step S203, the ECU 40 checks whether the rack position η is between the first threshold value η1 and the second threshold value η2. It is assumed that the first threshold value is 90 while the second threshold value is −90, as is the case with step S103, which is performed in the first embodiment.

When the rack position η is determined to be between the first threshold value and the second threshold value, that is, when −90<η<90 (when the determination in step S203 is YES), processing proceeds to step S204. If, on the other hand, the rack position η is not determined to be between the first threshold value and the second threshold value, that is, when η≦−90 or 90 (when the determination in step S203 is NO), processing proceeds to step S211.

In step S204, the ECU 40 calculates the basic transfer ratio. The basic transfer ratio is calculated in accordance with the steering angle θin and the vehicle speed V acquired in step S201. The method of calculating the basic transfer ratio is the same as described in connection with step S104, which is performed in the first embodiment. The ECU 40 determines the calculated basic transfer ratio G(θin, V) as the transfer ratio Gre.

Upon completion of step S204, processing proceeds to step S205. In step S211, the ECU 40 calculates the corrected transfer ratio. The corrected transfer ratio is calculated by correcting the basic transfer ratio in accordance with the position of the rack 6. The method of calculating the corrected transfer ratio is the same as described in connection with step S111, which is performed in the first embodiment. The ECU 40 determines the calculated corrected transfer ratio k(η)·G(θin, V) as the transfer ratio Gre.

Upon completion of S211, processing proceeds to step S205. In step S205, the ECU 40 sets the transfer ratio Gre determined in step S204 or S211 as the transfer ratio, and controls the drive of the first actuator 22 of the variable transfer ratio mechanism 20 so as to attain the transfer ratio determined as above.

Upon completion of step S205, processing finishes the series of processing steps shown in FIG. 6. Subsequently, when the ignition key is in the on-state, the ECU 40 resumes the series of processing steps shown in FIG. 6. That is, the series of processing steps shown in FIG. 6 is repeatedly performed when the ignition key is in the on-state.

As described above, in step S202, the ECU 40 functions as the rack position estimation section. In steps S203 and S204 and in steps S203 and S211, the ECU 40 functions as the transfer ratio determination section. In steps S204 and S211, the ECU 40 functions as the basic transfer ratio calculation section. In step S211, the ECU 40 functions as the corrected transfer ratio calculation section. In step S205, the ECU 40 functions as the first drive control section.

As described above, the ECU 40 includes the rack position estimation section, the transfer ratio determination section, the basic transfer ratio calculation section, the corrected transfer ratio calculation section, and the first drive control section as functional elements.

In the second embodiment, performing the above-described process makes it possible to decrease the movement speed of the rack 6 when it collides against the rack housing 8, as is the case with the first embodiment. Thus, the collision energy between the rack 6 and the rack housing 8 can be reduced. As a result, when the rack 6 collides against the rack housing 8, the torque applied to the gears included in the first gear mechanism 21 (collision torque Tgr) as a reaction can be reduced.

As described above, the second embodiment further includes the steered angle sensor 33, which detects the rotation angle of the output shaft 4, that is, the steered angle. The ECU 40 (rack position estimation section) estimates the position of the rack 6 in accordance with the steered angle detected by the steered angle sensor 33. The second embodiment can accurately detect the steered angle because it uses the steered angle sensor 33, which actually detects the steered angle. Therefore, the second embodiment enables the ECU 40 (rack position estimation section) to estimate the position of the rack 6 with higher accuracy than the first embodiment.

### Third Embodiment

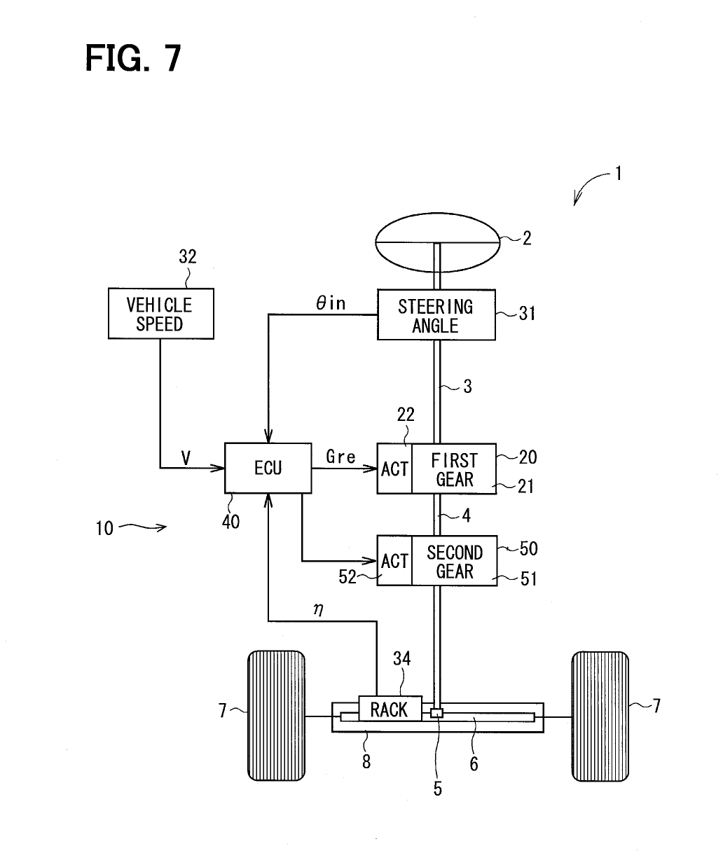

A steering control system 10 according to a third embodiment is shown in FIG. 7. The third embodiment differs from the first embodiment in configuration and partly differs from the first embodiment in steering-related processing.

The third embodiment further includes a rack position sensor 34, which serves as a rack position detection device. The rack position sensor 34 is mounted in the rack housing 8 to detect the position of the rack 6. The rack position sensor 34 outputs a signal indicating the detected position of the rack 6 to the ECU 40. The signal (η) output from the rack position sensor 34 corresponds to a value between −100 and 100(%).

When the steering wheel 2, the input shaft 3, the output shaft 4, and the steered wheel 7 are in neutral position, the signal (η) output from the rack position sensor 34 is 0(%). When η is 0, the rack 6 is positioned at the center of its movable range.

When the steering wheel 2 is continuously rotated in one direction (e.g., clockwise) to let the end of the rack 6 abut against the inner wall of the rack housing 8, the signal (η) output from the rack position sensor 34 is 100%. When η is 100%, the rack 6 is positioned at one end of its movable range, namely, at the maximum stroke position.

When the steering wheel 2 is continuously rotated in the other direction (e.g., counterclockwise) to let the end of the rack 6 abut against the inner wall of the rack housing 8, the signal (η) output from the rack position sensor 34 is −100%. When η is −100%, the rack 6 is positioned at the other end of its movable range, namely, at the maximum stroke position.

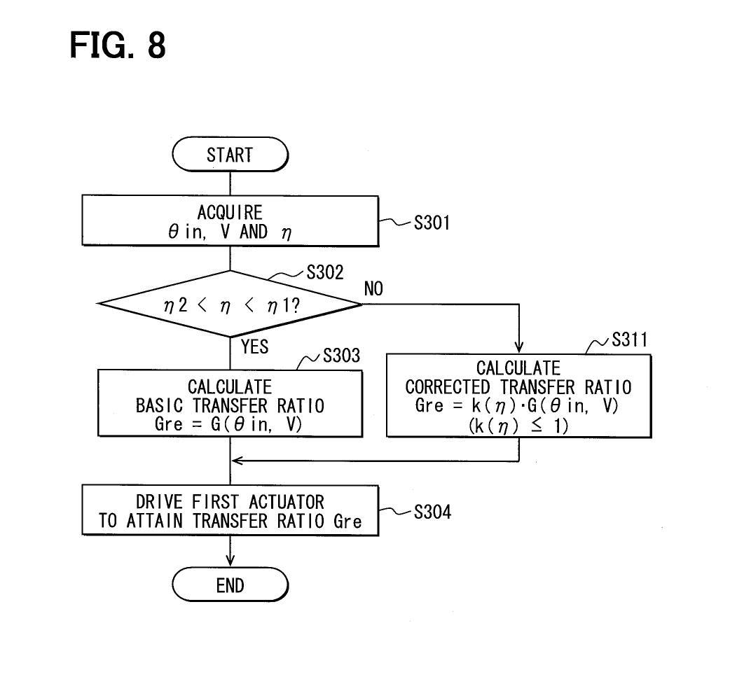

The ECU 40 is programmed to perform a steering process as shown in FIG. 8. A series of processing steps shown in FIG. 8 is initiated when, for instance, the driver turns on the ignition key of the vehicle 1.

In step S301, the ECU 40 acquires various signals (information) from the sensors. The ECU 40 acquires the rotation angle of the input shaft 3 that is detected by the steering angle sensor 31, namely, the steering angle θin. The ECU 40 acquires the speed of the vehicle 1 that is detected by the vehicle speed sensor 32, namely, the vehicle speed V. The ECU 40 also acquires the rack position η detected by the rack position sensor 34.

Upon completion of step S301, processing proceeds to step S302. In step S302, the ECU 40 checks whether the rack position η acquired in step S301 is between the first threshold value η1 and the second threshold value η2. It is assumed that the first threshold value is 90 while the second threshold value is −90, as is the case with step S103, which is performed in the first embodiment. Step S302 differs from step S103, which is performed in the first embodiment, in that the rack position η used in step S103 is estimated by the ECU 40 (rack position estimation section) whereas the rack position η used in step S302 is detected by the rack position sensor 34.

When the rack position η is determined to be between the first threshold value and the second threshold value, that is, when −90<η<90 (when the determination in step S302 is YES), processing proceeds to step S303. If, on the other hand, the rack position η is not determined to be between the first threshold value and the second threshold value, that is, when η≦−90 or 90≦η (when the determination in step S302 is NO), processing proceeds to step S311.

In step S303, the ECU 40 calculates the basic transfer ratio. The basic transfer ratio is calculated in accordance with the steering angle θin and the vehicle speed V acquired in step S301. The method of calculating the basic transfer ratio is the same as described in connection with step S104, which is performed in the first embodiment. The ECU 40 determines the calculated basic transfer ratio G(θin, V) as the transfer ratio Gre.

Upon completion of step S303, processing proceeds to step S304. In step S311, the ECU 40 calculates the corrected transfer ratio. The corrected transfer ratio is calculated by correcting the basic transfer ratio in accordance with the position of the rack 6, that is, the rack position η acquired in step S301. The method of calculating the corrected transfer ratio is the same as described in connection with step S111, which is performed in the first embodiment. Step S311 differs from step S111, which is performed in the first embodiment, in that the rack position η used in step S111 is estimated by the ECU 40 (rack position estimation section) whereas the rack position η used in step S311 is detected by the rack position sensor 34. The ECU 40 determines the calculated corrected transfer ratio k(η)G(θ in, V) as the transfer ratio Gre.

Upon completion of S311, processing proceeds to step S304. In step S304, the ECU 40 sets the transfer ratio Gre determined in step S303 or S311 as the transfer ratio, and controls the drive of the first actuator 22 of the variable transfer ratio mechanism 20 so as to attain the determined transfer ratio.

Upon completion of step S304, processing finishes the series of processing steps shown in FIG. 8. Subsequently, when the ignition key is in the on-state, the ECU 40 resumes the series of processing steps shown in FIG. 8. That is, the series of processing steps shown in FIG. 8 is repeatedly performed when the ignition key is in the on-state.

As described above, in steps S302 and S303 and in steps S302 and S311, the ECU 40 functions as the transfer ratio determination section.

In steps S303 and S311, the ECU 40 functions as the basic transfer ratio calculation section.

In step S311, the ECU 40 functions as the corrected transfer ratio calculation section. In step S304, the ECU 40 functions as the first drive control section.

As described above, the ECU 40 in the third embodiment includes the transfer ratio determination section, the basic transfer ratio calculation section, the corrected transfer ratio calculation section, and the first drive control section as functional elements.

In the third embodiment, performing the above-described process makes it possible to decrease the movement speed of the rack 6 when it collides against the rack housing 8, as is the case with the first embodiment. Thus, the collision energy between the rack 6 and the rack housing 8 can be reduced. As a result, when the rack 6 collides against the rack housing 8, the torque applied to the gears included in the first gear mechanism 21 (collision torque Tgr) as a reaction can be reduced.

As described above, the third embodiment further includes the rack position sensor 34, which detects the actual position of the rack 6. The ECU 40 (corrected transfer ratio calculation section) corrects the basic transfer ratio in accordance with the position of the rack 6 that is detected by the rack position sensor 34. Further, the ECU 40 (transfer ratio determination section) determines the transfer ratio in accordance with the position of the rack 6 that is detected by the rack position sensor 34. As described above, the third embodiment can accurately detect the position of the rack 6 by using the rack position sensor 34 that actually detects the position of the rack 6. Therefore, the third embodiment enables the ECU 40 (corrected transfer ratio calculation section) to correct the basic transfer ratio with increased accuracy.

### Fourth Embodiment

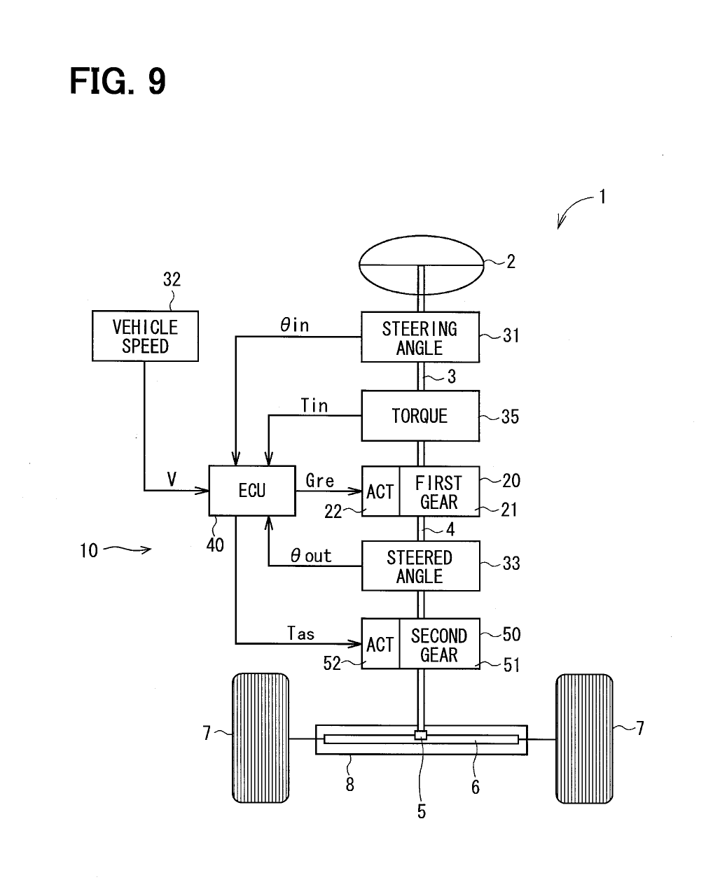

A steering control system 10 according to a fourth embodiment is shown in FIG. 9. The fourth embodiment differs from the second embodiment in configuration and partly differs from the second embodiment in steering-related processing.

The fourth embodiment further includes a torque sensor 35, which serves as a steering torque detection device. The torque sensor 35 is mounted on the input shaft 3 to detect a steering torque that is input to the input shaft 3 when the driver steers the steering wheel 2. The torque sensor 35 outputs a signal indicating the detected steering torque to the ECU 40.

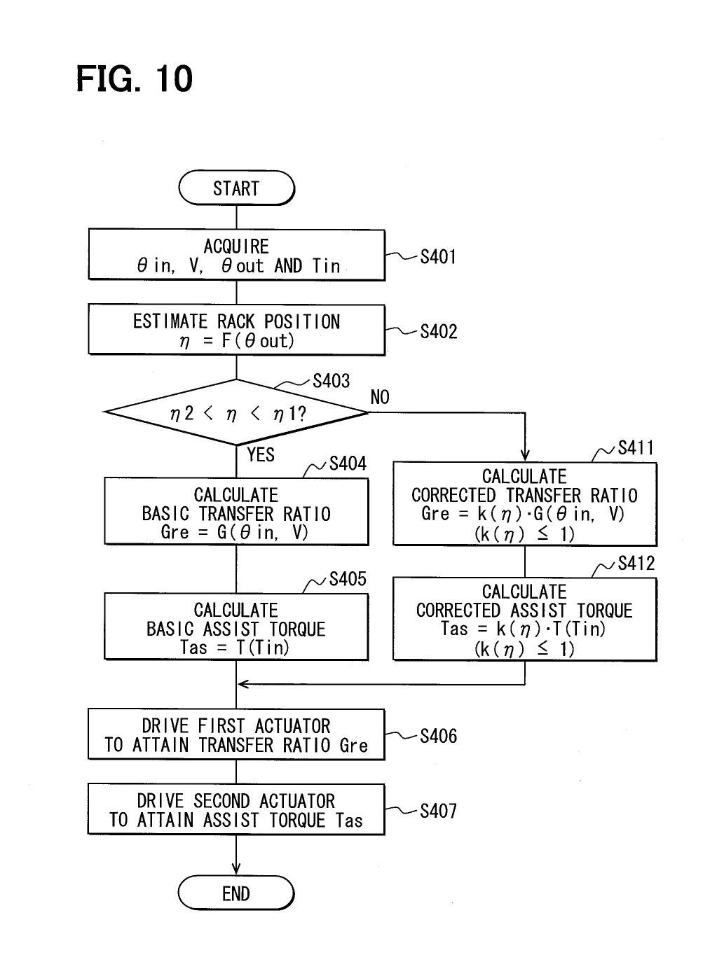

The ECU 40 is programmed to perform a steering process as shown in FIG. 10. A series of processing steps shown in FIG. 10 is initiated when, for instance, the driver turns on the ignition key of the vehicle 1.

In step S401, the ECU 40 acquires various signals (information) from the sensors. The ECU 40 acquires the rotation angle of the input shaft 3 that is detected by the steering angle sensor 31, namely, the steering angle θin. The ECU 40 acquires the speed of the vehicle 1 that is detected by the vehicle speed sensor 32, namely, the vehicle speed V. The ECU 40 acquires the rotation angle of the output shaft 4 that is detected by the steering angle sensor 33, namely, the steered angle θout. The ECU 40 also acquires the steering torque Tin detected by the torque sensor 35.

Upon completion of step S401, processing proceeds to step S402. In step S402, the ECU 40 estimates the position of the rack 6. More specifically, the ECU 40 estimates the position of the rack 6 in accordance with the steered angle θout acquired in step S401. The method of estimating the position of the rack 6 is the same as described in connection with step S202, which is performed in the second embodiment.

Upon completion of step S402, processing proceeds to step S403. In step S403, the ECU 40 checks whether the rack position η is between the first threshold value η and the second threshold value η2. It is assumed that the first threshold value is 90 while the second threshold value is −90, as is the case with step S203, which is performed in the second embodiment.

When the rack position η is determined to be between the first threshold value and the second threshold value, that is, when −90<η<90 (when the determination in step S403 is YES), processing proceeds to step S404. If, on the other hand, the rack position η is not determined to be between the first threshold value and the second threshold value, that is, when η≦−90 or 90≦η (when the determination in step S403 is NO), processing proceeds to step S411.

In step S404, the ECU 40 calculates the basic transfer ratio. The basic transfer ratio is calculated in accordance with the steering angle θin and the vehicle speed V acquired in step S401. The method of calculating the basic transfer ratio is the same as described in connection with step S204, which is performed in the second embodiment. The ECU 40 determines the calculated basic transfer ratio G(θin, V) as the transfer ratio Gre.

Upon completion of step S404, processing proceeds to step S405. In step S405, the ECU 40 calculates a basic assist torque. The basic assist torque is calculated in accordance with the steering torque Tin acquired in step S401. The basic assist torque is calculated in accordance with a function whose variable is Tin by the following equation (5).

Tas=T(Tin) (5)

The ECU 40 sets the calculated basic assist torque T(Tin) into the assist torque Tas. That is, the ECU 40 determines the basic assist torque T(Tin) as the assist torque Tas.

Upon completion of S405, processing proceeds to step S406. In step S411, the ECU 40 calculates the corrected transfer ratio. The corrected transfer ratio is calculated by correcting the basic transfer ratio in accordance with the position of the rack 6. The method of calculating the corrected transfer ratio is the same as described in connection with step S211, which is performed in the second embodiment. The ECU 40 determines the calculated corrected transfer ratio k(η)·G(θin, V) as the transfer ratio Gre.

Upon completion of S411, processing proceeds to step S412. In step S412, the ECU 40 calculates a corrected assist torque. In the fourth embodiment, the corrected assist torque is calculated by correcting the basic assist torque in accordance with the position of the rack 6, namely, the position of the rack 6 that is estimated in step S402. More specifically, the corrected assist torque is calculated by multiplying the basic assist torque T(Tin) by the correction factor k(η), which is calculated in accordance with the position η of the rack 6.

The correction factor k(η) is the same as the correction factor k(η) that is used in the preceding embodiments and in step S411 to calculate the corrected transfer ratio. More specifically, the correction factor k(η) is a value not greater than 1. The relationship between the correction factor k(η) and the rack position η is exemplarily shown in FIG. 3B. As shown in FIG. 3B, the correction factor k(η) is 1 when −90<η<90. When 90≦η≦100, the correction factor k(η) gradually decreases from 1 to 0 while η changes from 90 to 100. When −100≦η≦−90, the correction factor k(η) gradually decreases from 1 to 0 while η changes from −90 to −100. When η is 100 or −100, the correction factor k(η) is 0.

When η is a third threshold value (for example, same as the first threshold value 90), the position of the rack 6 corresponds to a third position. When η is a fourth threshold value (for example, same as the second threshold value −90), the position of the rack 6 corresponds to a fourth position.

The method of calculating the basic assist torque T(Tin) is the same as described in connection with step S405. The corrected assist torque is calculated by the following equation (6).

Tas=k(η)·T(Tin) (6)

That is, the calculated corrected assist torque k(η)·T(Tin) decreases when the rack 6 moves from the third position (90%) to one end (100%) or from the fourth position (−90%) to the other end (−100%). The ECU 40 sets the calculated corrected assist torque k(η)·T(Tin) into the assist torque Tas. More specifically, the ECU 40 determines the corrected assist torque k(η)·T(Tin) as the assist torque Tas.

Upon completion of step S412, processing proceeds to step S406. In step S406, the ECU 40 sets the transfer ratio Gre determined in step S404 or S411 as the transfer ratio, and controls the drive of the first actuator 22 of the variable transfer ratio mechanism 20 so as to attain the determined transfer ratio.

Upon completion of step S406, processing proceeds to step S407. In step S407, the ECU 40 sets the assist torque Tas determined in step S405 or S412 as the assist torque, and controls the drive of the second actuator 52 so that the assist torque is applied to the output shaft 4.

Upon completion of step S407, processing finishes the series of processing steps shown in FIG. 10. Subsequently, when the ignition key is in the on-state, the ECU 40 resumes the series of processing steps shown in FIG. 10. That is, the series of processing steps shown in FIG. 10 is repeatedly performed when the ignition key is in the on-state.

As described above, in step S402, the ECU 40 functions as the rack position estimation section. In steps S403 and S404 and in steps S403 and S411, the ECU 40 functions as the transfer ratio determination section. In steps S403 and S405 and in steps S403 and S412, the ECU 40 functions as the assist torque determination section. In steps S404 and S411, the ECU 40 functions as the basic transfer ratio calculation section. In steps S405 and S412, the ECU 40 functions as the basic assist torque calculation section. In step S411, the ECU 40 functions as the corrected transfer ratio calculation section. In step S412, the ECU 40 functions as the corrected assist torque calculation section. In step S406, the ECU 40 functions as the first drive control section. In step S407, the ECU 40 functions as the second drive control section.

As described above, the ECU 40 in the fourth embodiment includes the rack position estimation section, the transfer ratio determination section, the assist torque determination section, the basic transfer ratio calculation section, the basic assist torque calculation section, the corrected transfer ratio calculation section, the corrected assist torque calculation section, the first drive control section, and the second drive control section as functional elements.

In the fourth embodiment, performing the above-described process makes it possible to further decrease the movement speed of the rack 6 when it collides against the rack housing 8, as compared to the second embodiment. Thus, the collision energy between the rack 6 and the rack housing 8 can be further reduced. As a result, when the rack 6 collides against the rack housing 8, the torque applied to the gears included in the first gear mechanism 21 and to the gear included in the second gear mechanism 51 (collision torque Tgr) as a reaction can be further reduced.

As described above, the ECU 40 (corrected assist torque calculation section) calculates the corrected assist torque by making corrections so that the basic assist torque decreases when the rack 6 moves from the predetermined third position (90%), which is close to one end (100%) of the movable range, to the one end, or from the predetermined fourth position (−90), which is close to the other end (−100) of the movable range, to the other end.

When the rack 6 is between the first position and the second position, the ECU 40 (assist torque determination section) determines the basic assist torque calculated by the basic assist torque calculation section as the assist torque. When, on the other hand, the rack 6 is between the first position and the one end or between the second position and the other end, the ECU 40 (assist torque determination section) determines the corrected assist torque calculated by the corrected assist torque calculation section as the assist torque.

In a situation where the rack 6 is positioned close to one end or the other end of its movable range, the above-described configuration makes corrections so that the assist torque decreases when the driver steers the steering wheel 2 to move the rack 6 toward the one end or the other end of the movable range, that is, the rack 6 approaches the maximum stroke position. This decreases the movement speed of the rack 6 when it collides against the rack housing 8. As a result, the collision torque between the rack 6 and the rack housing 8 can be reduced.

As described above, the steering control system 10 having the steering force assist mechanism 50 in addition to the variable transfer ratio mechanism 20 can reduce the collision torque that is generated when the rack 6 collides against the rack housing 8. This makes it possible to set a low allowable torque for the first gear mechanism 21 and the second gear mechanism 51 and reduce the sizes of the first gear mechanism 21 and the second gear mechanism 51. Hence, it is possible not only to decrease the physical size and weight of the steering control system, but also to reduce the cost of manufacturing the steering control system. Further, as the collision torque between the rack 6 and the rack housing 8 is reduced, damage to the first gear mechanism 21 and the second gear mechanism 51 can be avoided to increase the reliability of the steering control system.

### Other Embodiments

Physical configurations and functional configurations of the foregoing embodiments may be combined in any suitable combination.

In the fourth embodiment, step S405 is performed after step S404, and that step S412 is performed after step S411, and further that step S407 is performed after step S406. However, it is possible to perform step S405 before step S404, perform step S412 before step S411, and perform step S407 before step S406. An alternative is to simultaneously perform steps S404 and S405, simultaneously perform steps S411 and S412, and simultaneously perform steps S406 and S407.

Further, in the fourth embodiment, the third position and the fourth position are set to be equal to the first position (90%) and the second position (−90%), respectively. However, the third position and the fourth position may differ from the first position and the second position, respectively. Further, the first position and the third position may be set to any positions other than 90% position as far as they are close to one end (100%) of the movable range. Similarly, the second position and the fourth position may be set to any positions other than −90% position as far as they are close to the other end (−100%) of the movable range.

In the foregoing embodiments, the basic transfer ratio calculated by the basic transfer ratio calculation section increases with a decrease in the vehicle speed and decreases with an increase in the vehicle speed. However, the basic transfer ratio calculated by the basic transfer ratio calculation section varies in any manner with the vehicle speed. Alternatively, a predetermined basic transfer ratio may be used without regard to the vehicle speed.

In the foregoing embodiments, a differential gear mechanism may be employed as the first gear mechanism. Some other gear mechanism, such as a planetary gear mechanism or a harmonic drive gear mechanism, may be used as the first gear mechanism as far as the transfer ratio can be changed by driving the first actuator and the first gear mechanism.

In the foregoing embodiments, a column assist electric power steering mechanism is employed to apply the assist torque to the output shaft with the second gear mechanism engaged with the output shaft. However, a rack assist electric power steering mechanism may be employed to apply the assist torque to the rack with the second gear mechanism engaged with the rack.

In the foregoing embodiments, an electric motor is employed as the first actuator and as the second actuator. However, a motive power source other than an electric motor may be employed as the first actuator and as the second actuator as far as the drive of the first and second actuators can be controlled as desired.

What is claimed is:

1. A steering control system for a vehicle having an input shaft coupled to a steering wheel of the vehicle, an output shaft disposed rotatably relative to the input shaft, a rack that reciprocates in a longitudinal direction when the output shaft rotates, a steered wheel that turns when the rack reciprocates, and a rack housing in which the rack is reciprocally housed, the steering control system comprising:
a variable transfer ratio mechanism including a first gear mechanism that transmits rotation of the input shaft to the output shaft and a first actuator that drives the first gear mechanism, the variable transfer ratio mechanism providing a variable transfer ratio, which is the ratio between the rotation angle of the output shaft indicating a steered angle and the rotation angle of the input shaft indicating a steering angle of the steering wheel;
a steering angle detection device that detects the steering angle;
a basic transfer ratio calculation section that calculates a basic transfer ratio in accordance with the steering angle detected by the steering angle detection device;
a corrected transfer ratio calculation section that calculates a corrected transfer ratio by correcting the basic transfer ratio in accordance with a position of the rack;
a transfer ratio determination section that determines either the basic transfer ratio or the corrected transfer ratio as a transfer ratio in accordance with the position of the rack; and
a first drive control section that controls the first actuator in accordance with the transfer ratio determined by the transfer ratio determination section,
wherein the corrected transfer ratio calculation section calculates the corrected transfer ratio by making corrections so that a value of the basic transfer ratio decreases when the rack moves from a predetermined first position, which is close to a first end of a movable range, to the first end or from a predetermined second position, which is close to a second end of the movable range opposite to the first end, to the second end, and
wherein the transfer ratio determination section determines the basic transfer ratio as the transfer ratio when the rack is between the first position and the second position, and determines the corrected transfer ratio as the transfer ratio when the rack is between the first position and the first end or between the second position and the second end.

2. The steering control system according to claim 1, further comprising:
a speed detection device that detects a speed of the vehicle,
wherein the basic transfer ratio calculation section performs calculations so that the calculated value of the basic transfer ratio increases with a decrease in a value of the speed of the vehicle, which is detected by the speed detection section, and decreases with an increase in the value of the speed of the vehicle, which is detected by the speed detection section.

3. The steering control system according to claim 1, further comprising:
a rack position estimation section that estimates the position of the rack in accordance with the steered angle,
wherein the corrected transfer ratio calculation section corrects the basic transfer ratio in accordance with the position of the rack that is estimated by the rack position estimation section, and
wherein the transfer ratio determination section determines the transfer ratio in accordance with the position of the rack that is estimated by the rack position estimation section.

4. The steering control system according to claim 3, further comprising:
a steered angle estimation section that estimates the steered angle in accordance with the steering angle detected by the steering angle detection device and with the transfer ratio determined by the transfer ratio determination section,
wherein the rack position estimation section estimates the position of the rack in accordance with the steered angle estimated by the steered angle estimation section.

5. The steering control system according to claim 3, further comprising:
a steered angle detection device that detects the steered angle,
wherein the rack position estimation section estimates the position of the rack in accordance with the steered angle detected by the steered angle detection section.

6. The steering control system according to claim 1, further comprising:
a rack position detection device that detects the position of the rack,
wherein the corrected transfer ratio calculation section corrects the basic transfer ratio in accordance with the position of the rack that is detected by the rack position detection section, and
wherein the transfer ratio determination section determines the transfer ratio in accordance with the position of the rack that is detected by the rack position detection section.

7. The steering control system according to claim 1, further comprising:
a steering force assist mechanism including a second gear mechanism that engages with the output shaft or the rack and a second actuator that drives the second gear mechanism, the steering force assist mechanism assisting a steering operation of the steering wheel by using an assist torque that is generated when the second actuator and the second gear mechanism are driven;
a steering torque detection device that detects a steering torque that is input to the input shaft when the driver steers the steering wheel;
a basic assist torque calculation section that calculates a basic assist torque in accordance with the steering torque detected by the steering torque detection section;
a corrected assist torque calculation section that calculates a corrected assist torque by correcting the basic assist torque in accordance with the position of the rack;
an assist torque determination section that determines either the basic assist torque or the corrected assist torque as an assist torque in accordance with the position of the rack; and
a second drive control section that controls the second actuator in accordance with the assist torque determined by the assist torque determination section,
wherein the corrected assist torque calculation section calculates the corrected assist torque by making corrections so that a value of the basic assist torque decreases when the rack moves from a predetermined third position, which is close to the first end, to the first end, or from a predetermined fourth position, which is close to the second end, to the second end,
wherein the assist torque determination section determines the basic assist torque as the assist torque when the rack is between the third position and the fourth position, and determines the corrected assist torque as the assist torque when the rack is between the third position and the first end or between the fourth position and the second end.
